(19) United States
(12) Patent Application Publication
(10) Pub. No.: US 2010/0148762 A1
(43) Pub. Date: Jun. 17, 2010

(54) MAGNETIC POSITION SENSOR

(75) Inventors: Andreas IMHOF, Chur (CH); Josua LANTER, Spearwood (AU)

Correspondence Address: BUCHANAN, INGERSOLL & ROONEY PC, POST OFFICE BOX 1404, ALEXANDRIA, VA, 22313-1404, US

(73) Assignee: POLYCONTACT AG, Chur (CH)

(21) Appl. No.: 12/483,664

(22) Filed: Jun. 12, 2009

Related U.S. Application Data
(63) Continuation of application No. PCT/CH2007/000586, filed on Nov. 22, 2007.

(30) Foreign Application Priority Data
Dec. 12, 2006 (CH) 2013/06

(51) Int. Cl. G01B 7/14

(52) U.S. Cl. 324/207.13

(57) ABSTRACT

A magnetic position sensor is disclosed for detecting the location of a component which can be moved along an actuating path. The sensor can be located along an actuating path for generating a magnetic field whose polarity changes along the actuating path. At least one galvanomagnetic detector is provided which is located in a region of action of the magnetic field with at least two measurement fields and which can be adjusted relative to the magnetic field along the actuating path, wherein the galvanomagnetic detector is made for vectorial evaluation of the magnetic field.

### RELATED APPLICATIONS

This application claims priority as a continuation application under 35 U.S.C.§120 to PCT/CH2007/000586, which was filed as an International Application on Nov. 22, 2007 designating the U.S., and which claims priority to Swiss Application 2013/06 filed in Switzerland on Dec. 12, 2006. The entire contents of these applications are hereby incorporated by reference in their entireties.

### FIELD

A magnetic position sensor is disclosed that can, for example, be used for detecting the location of a component which can be moved along a given path.

### BACKGROUND INFORMATION

Electronic components are increasingly penetrating into areas which for a long time had been assigned mainly to the mechanical domain. This also relates especially to the automobile industry which is equipping its products with electronics, according to a general trend, in order to electronically detect, control and regulate mechanical functions and/or to communicate information to the user. To convert mechanical functions of a component into signals which can be processed electronically and vice versa, sensor arrangements and actuators are used as connecting members between the two worlds.

Position sensors are used to detect the location or state of motion of a mechanical component. The information acquired by the position sensors can be converted into electrical signals which change depending on the change in the position of the component. In many mechanical products, position sensors are components which enable intelligent control.

The detection of a distance traversed by a component along a given path is of interest for example when materials are being cut off. The analog translational position sensors used for this purpose can work according to the ohmic or induction principle. For both principles, analog (continuous) conversion of the distance traversed into an electrical signal is used. In position sensors using the ohmic measurement principle, the electrical voltage can be tapped via a slider from a resistance wire; its magnitude is a function of the wire length With these potentiometers, the slider and the wire are subject to relatively great wear. For the induction principle, in the measurement system, an AC voltage induces a magnetic field which generates an electrical voltage in a coil. The coil is moved relative to the remaining measurement system.

The voltage which has been induced in the coil depends on its position in the measurement system. Using suitable electronic circuits a position measurement signal can be obtained therefrom. The measurement process is contactless; but an AC voltage source used and a relatively great electronic effort can be involved to produce the position measurement signal.

Other known path measurement systems use, for example, magnetic tapes whose magnetic field is tapped by a reading head and converted into a position or path measurement signal. For cable length transducers, a cable is wound onto a drum or guided over a roll according to the distance traversed. The revolutions are detected and a path measurement signal is generated therefrom. In the magnetostrictive principle a movable magnet changes its acoustic reflection properties. By way of ultrasonic propagation time measurement in conjunction with relatively complex evaluation electronics, the location of the magnet and thus the displacement path are ascertained. U.S. Pat. No. 6,753,680 B2 discloses a position sensor which comprises two flux conducting rails and permanent magnets which are located on the ends of the flux conducting rails which run parallel to one another and at a distance from one another. In the gap between the flux conducting rails there is a Hall sensor which can be moved relative to the lengthwise extension of the flux conducting rails. The output signal which appears at the output of the Hall sensor and which changes as result of the relative displacement continues to be processed and is used as a measure for the traversed distance of the monitored component. These known systems work incrementally, i.e., information about the absolute position of the moving component is only available when, prior to the measurement, a zero point position is established according to the base output signal of the sensor. If, for example, in the case of a seat adjustment the seat is adjusted before the engine and thus the vehicle electrical system and electronics are started, using the known position sensors it is almost impossible to determine the exact position of the seat. Moreover, the known magnetic position sensors are highly dependent on the amplitude of the detected magnetic field. This results in that, for example, the Hall sensor should be calibrated very precisely with respect to the flux conducting rails. Imprecision in the calibration or vibration-induced movements can have a direct adverse affect on the measurement result.

### SUMMARY

A magnetic position sensor is disclosed for detecting the location of a component which can be moved along an actuating path, comprising: means, located along an actuating path, for generating a magnetic field whose polarity changes along the actuating path; and at least one galvanomagnetic detector which is located in a region of action of the magnetic field with at least two measurement fields and which can be adjusted relative to the magnetic field along the actuating path, wherein the galvanomagnetic detector is made for vectorial evaluation of the magnetic field.

### BRIEF DESCRIPTION OF THE DRAWINGS

Other advantages and features of the invention will become apparent from the following description of schematics of exemplary embodiments of the analog magnetic position sensor as claimed. The figures, which are not to scale, are as follows:

FIG. 1 shows a schematic structure of a first exemplary embodiment of an analog magnetic position sensor;

FIG. 2 shows an exemplary version of a permanent magnet arrangement or of a permanent magnet of the magnetic position sensor as shown in FIG. 1;

FIG. 3 shows a schematic structure of an exemplary magnetic position sensor with two permanent magnets;

FIG. 4 shows a schematic structure of an exemplary magnetic position sensor with three permanent magnets;

FIG. 5 shows an exemplary signal characteristic measured by the magnetic position sensor with a structure as shown in FIG. 4 along the displacement path;

FIG. 6 shows an exemplary magnetic position sensor as shown in FIG. 4 with indications of dimensions;

FIG. 7 shows an exemplary arrangement of the permanent magnet along a curved displacement path; and

FIG. 8 shows a twisted permanent magnet of an exemplary magnetic position sensor, which magnet runs arbitrarily in space.

### DETAILED DESCRIPTION

A magnetic position sensor is disclosed which makes it possible to detect a distance which has been traversed along a given path and to ascertain the absolute position of the movable component, easily and without great electronic effort. The magnetic position sensor does not unconditionally have to be positively driven. Calibration precision can be reduced, and the position sensor can be configured largely insensitive to vibrations. The position sensor can operate free of wear, and have a simple and economical structure.

An exemplary magnetic position sensor as disclosed herein for detecting the location of components can be moved along a given path. Such a magnetic position sensor can have a means located along the actuating path for generating a magnetic field whose polarity changes along the actuating path of the component, and have at least one galvanomagnetic detector located in the region of action of the magnetic field with which adjustment is possible relative to the magnetic field along the actuating path of the component, and at least two measurement fields. The galvanomagnetic detector can be made for vectorial evaluation of the magnetic field.

The name galvanomagnetic detector is used as a generic term for detectors whose function is based on different galvanomagnetic effects which arise in a conductor or semiconductor through which an electrical current has flowed in interaction with a magnetic field. The effects can be of a longitudinal or transverse nature. In particular the term includes, for example, Hall sensors and magnetoresistors, but also magnetoresistive detectors which are based on the principle of magnetically caused resistance effects in ferromagnetic conductors through which current has flowed.

Exemplary magnetic position sensors as disclosed herein are based on a galvanomagnetic detector which is made for vectorial evaluation of a magnetic field which changes its polarity over its lengthwise extension. Thus, the angle of the vector of the magnetic field is directly detected and evaluated. Due to its being independent of amplitude, the calibration precision of the position sensor can be distinctly reduced. It is sufficient that the galvanomagnetic detector is located in the general region of action of the magnetic field in which its ability to detect changes in the direction of the magnetic field is ensured. This allows, depending on the reasonably used magnetic field intensities, calibration tolerances into the centimeter range. Therefore positive driving of the galvanomagnetic detector in the magnetic field can be omitted. Due to the large calibration tolerances the magnetic position sensor is also largely insensitive to vibrations. The measurement principle is contactless. Due to the abandonment of positive driving the mechanical wear of the magnetic position sensor can also be reduced. This favors its use for example in automobile construction. By the magnetic field being vectorially detected, i.e. the angle of the magnetic field vector being detectable, incremental measurement with establishment of the zero point is not necessary for ascertaining the position of the component which can be moved along the path. The absolute position of the component can be determined solely from the direction of the magnetic field. The magnetic position sensor made as disclosed herein manages without flux conducting rails for the magnetic field and without positive driving. In this way, compared to known magnetic sensors, it can be built much more easily and economically.

In one exemplary embodiment of the magnetic position sensor, the galvanomagnetic detector comprises four measurement fields which are arranged in the shape of a cross. Two measurement fields which are opposite one another on a crossbeam are coupled to one another. Here the arrangement of the position sensor can ensure that all measurement fields are penetrated essentially perpendicularly to the field lines of the magnetic field. The arrangement of coupled measurement fields allows a higher signal/noise ratio. The crossed magnetic fields directly allow evaluation of the angle of the vector of the magnetic field by way of the arctangent, and therefrom by way of the an essentially linear relationship the determination of the position of the observed component. The measurement fields can be made advantageously as magnetoresistors.

One exemplary embodiment of the magnetic position sensor calls for the galvanomagnetic detector to be a Hall sensor element with two differential Hall sensors which are arranged crossed. The function of differential Hall sensors is well recognized, and they are available in different versions. The arrangement of two differential Hall sensors located crossed perpendicular to one another allows the above described simple position determination by way of the arctangent of the angle of the vector of the magnetic field.

The means for generating the magnetic field comprises at least one permanent magnet which is polarized perpendicularly to the measurement direction and whose magnetic field polarity changes over its lengthwise extension. The change of the direction of the magnetic field vector over the lengthwise extension of the permanent magnet can be detected and evaluated as a function of the angle. The angle of the vector of the magnetic field is in a linear relationship to the displacement of the component. In this way the respective measured angle can be assigned directly to the position of the adjustable component.

One version of changing the polarity of the permanent magnet over its lengthwise extension includes the permanent magnet which is polarized vertically to the measurement direction being twisted by at least 180° over its lengthwise extension. Exemplary embodiments are not limited to the linear extension of the permanent magnet here. Another embodiment of the magnetic position sensor can provide for the permanent magnet to assume any curve in space. Thus, any three-dimensional paths of motion of a component can be accordingly reproduced and the position of the component can be ascertained anywhere simply by vectorial evaluation of the magnetic field.

An exemplary embodiment of the magnetic position sensor calls for the means for generating the magnetic field to comprise two or more permanent magnets which are polarized perpendicularly to the measurement direction and to be arranged to one another such that the adjacent magnets have opposite polarities. Permanent magnets which are adjacent to one another can be located at a distance from, for example, 10 mm to 100 mm from one another. The permanent magnets can be characterized by the magnet volume and the self-remanence. For a magnet, for example measuring 2×3×5 mm, the last digit “5” indicates the through-magnetization. The permanent magnet is thus through-magnetized by 5 mm. A permanent magnet measuring 2×5×3 mm is through-magnetized by 3 mm. Exemplary permanent magnets which can be used herein can have a self-remanence of 100 mT to 1.5 T and a diameter from 2 mm to 30 mm. The permanent magnets however can also have a shape other than cylindrical. The length of the permanent magnet can be, for example, approximately (e.g., ±10%) 0.1 times to twice the diameter. The distance of the measurement fields of the galvanomagnetic detector to the permanent magnet can be, for example, 1 mm to 50 mm.

The individual permanent magnets can be located along a linearly running path or along a curved plane path. In another embodiment of the magnetic position sensor, the permanent magnets can be located along a path in space with any curvature. Depending on the arrangement of the permanent magnets, linear displacements, displacements along the curved plane path or along a path which runs with any curvature in space can be evaluated in order to determine the respective position of the adjustable component.

The analog evaluation between 2 to 3 magnets at a time can be supplemented with digital encoding so that a longer linear distance can be measured via several magnets. Thus, three Hall sensors at a time can each ascertain whether the measurement is taken in the N-S-N region or the S-N-S. With repetitive interrogation of several N-S-N-S-N poles the region can be detected with a digital switch, such as with digital Hall effect switches on the same or on a separate track. The detected absolute signal is then composed of the linear signal of the galvanomagnetic detector and the digital signal of one or more digital switches, for example digital Hall effect sensors.

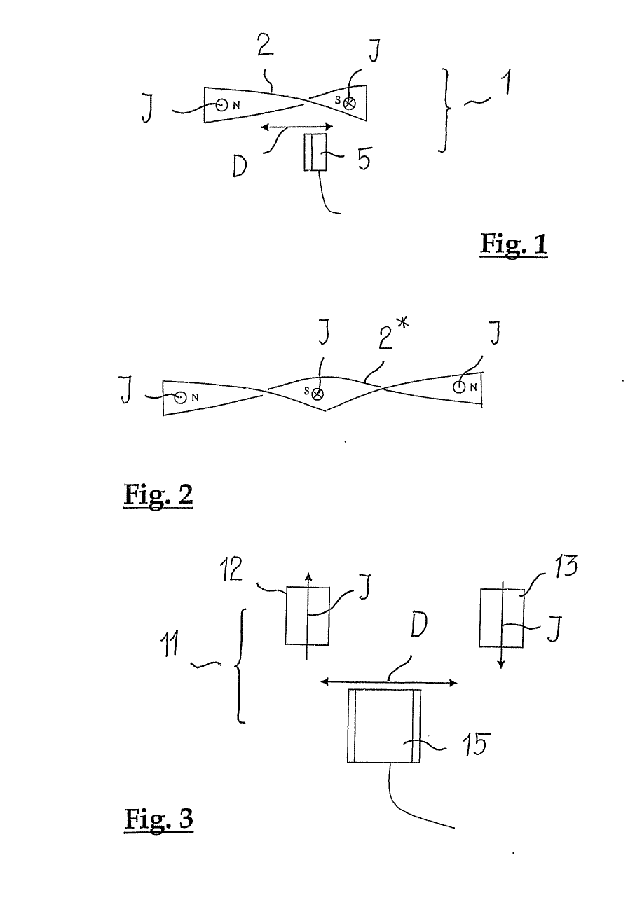

FIG. 1 schematically shows a fundamental structure of an exemplary magnetic position sensor as disclosed herein, labelled with reference number 1 overall. The exemplary magnetic position sensor 1 which can be used, for example, in building automobiles for monitoring of a movable component, for example a seat, or in any other suitable application, comprises one permanent magnet 2 and one galvanomagnetic detector 5.

The name galvanomagnetic detector is used here as a generic term for detectors whose operation is based on different galvanomagnetic effects which arise in a conductor or semiconductor through which an electrical current has flowed in interaction with a magnetic field. The effects can be of a longitudinal or transverse nature. In particular, the term includes Hall sensors and magnetoresistors, but also magnetoresistive detectors which are based on the principle of magnetically caused resistance effects in ferromagnetic conductors through which current has flowed.

The permanent magnet 2 can be twisted over its lengthwise extension which corresponds to the length of the displacement path of a component which is to be monitored. In the described case the twisting is 180° from one end of the permanent magnet 2 to the other end. The polarity of the magnetic field within the permanent magnet which is labelled J in FIG. 1 changes its direction accordingly. While the polarity J of the magnetic field points out of the plane of the drawing at the magnetic north pole N, at the magnetic south pole S it runs into the plane of the drawing on the other end of the permanent magnet 2. On the magnetic north pole N the pertinent south pole is facing away from the observer. On the south pole S facing the observer, the pertinent north pole is invisible to the observer.

Generally the permanent magnet 2 of the magnetic position sensor is located stationary while the galvanomagnetic detector 5 is movable. The displacement direction of the detector 5 which corresponds to the measurement direction is indicated by the double arrow D. The measurement direction D runs perpendicular to the polarity J of the magnetic field which has been generated by the permanent magnet 2. The galvanomagnetic detector 5 has at least two measurement fields whose arrangement allows direct vectorial evaluation of the magnetic field. By the magnetic field being vectorially detected, i.e. the angle of the magnetic field vectors being detectable, incremental measurement with establishment of the zero point is not necessary for ascertaining the position of the components which can be moved along the path. The absolute position of the components can be determined solely from the direction of the magnetic field.

FIG. 2 shows an exemplary permanent magnet of one alternative embodiment of the magnetic position sensor. The permanent magnet provided with reference number 2* is twisted by 360° over its lengthwise extension. The vector J of the polarity of the magnetic field on one end of the permanent magnet 2* points out of the plane of the drawing at the magnetic north pole N, changes its angle up to the magnetic south pole S by 180°, and points into the plane of the drawing in order to point out of the plane of the drawing again after another revolution by 180° on the magnetic north pole N on the other end of the permanent magnet 2*. This execution of the permanent magnet 2 of the magnetic position sensor allows detection of a longer displacement distance of the monitored component.

FIG. 3 shows one alternative exemplary embodiment of a magnetic position sensor. The magnetic position sensor which is labelled 11 overall comprises two permanent magnets 12, 13 and one galvanomagnetic detector 15. The permanent magnets 12, 13 are arranged such that within the permanent magnets the vectors J of the magnetic field, i.e. their polarities, run opposite one another. The displacement direction which corresponds to the measurement direction is in turn provided with reference number D and runs perpendicular to the polarities J of the two permanent magnets 12, 13.

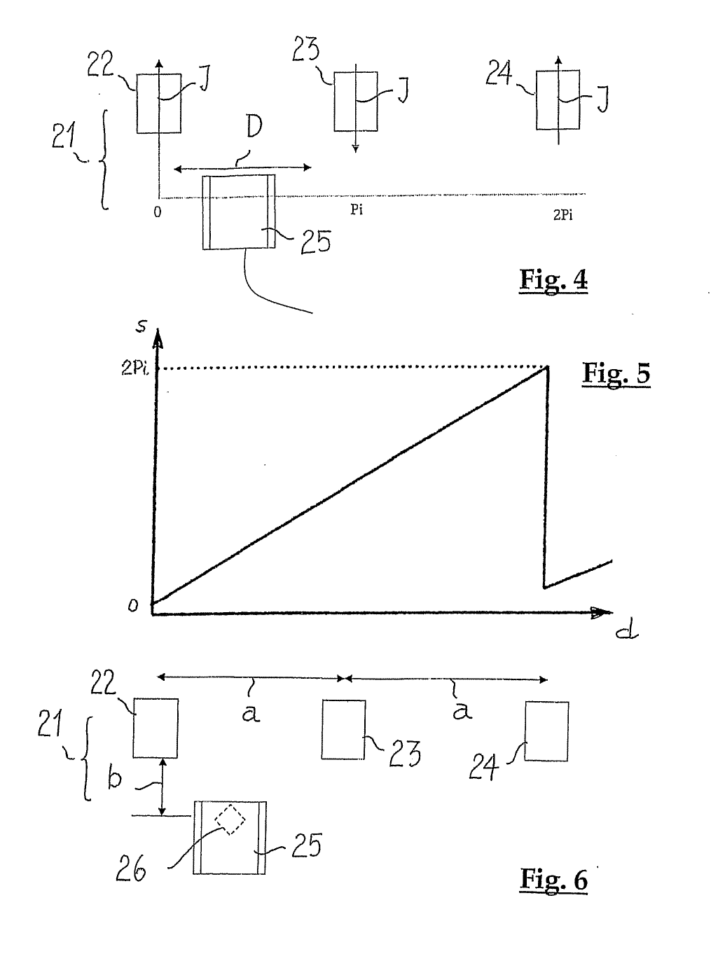

FIG. 4 shows another exemplary embodiment of a magnetic position sensor which is labelled with reference number 21 overall. It comprises three individual magnets 22, 23, 24 and a galvanomagnetic detector 25. The polarities J of the magnetic field within two adjacent permanent magnets run oppositely. The displacement direction indicated in turn with the double arrow D=measurement direction runs perpendicular to the polarities J of the permanent magnet 22, 23, 24. In FIG. 4 the initial position on the permanent magnet 22 is indicated with 0. On the permanent magnet 23 which has a polarity J which has been turned by 180° the position is labelled Pi. Accordingly the position of the permanent magnet 24 whose polarity J corresponds to that of the permanent magnet 22 is labelled 2Pi.

FIG. 5 shows an exemplary diagram in which the signal characteristic “s” measured by the galvanomagnetic detector is plotted over the displacement path “d”. The linearly arranged permanent magnets 22, 23, 24 define a linear displacement path. The magnetic field which is stretched from one permanent magnet to the adjacent permanent magnet with opposite polarity J changes its direction along the displacement path. The angular dependency of the magnetic field which results therefrom can be directly detected by the galvanomagnetic detector and is referenced directly to a displacement path “s” in an arctangent relationship. The superposition of the magnetic fields generated by the permanent magnets 22, 23, 24 yields an essentially (e.g., ±10%) linear relationship between the displacement path “d” and the signal “s” measured by the galvanomagnetic detector 25. Thus, the position of the component which has moved along the displacement path “d” can be determined from the detected angle of the magnetic field. Establishing the zero point, as in the incremental measurement process of the prior art, can be omitted.

FIG. 6 again shows the arrangement of the permanent magnet 22, 23, 24 and of the galvanomagnetic detector 25 of the magnetic position sensor 21 as shown in FIG. 4. The distance between adjacent permanent magnets is labelled with reference letter “a” and is for example 10 mm to 100 mm, preferably 20 mm to 60 mm. The measurement fields of the galvanomagnetic detector 25 whose location is indicated at 26 in FIG. 6 can have a distance from the permanent magnet which is labelled “b” and which is for example 5 mm to 20 mm, preferably 8 mm to 12 mm. The permanent magnets used measure 3×3×3 mm to 30×30×5 mm, preferably 4×4×2 mm to 8×8×3 mm, or for a cylindrical execution have the corresponding base area, and a self-remanence from 0.1 T to 2 T, preferably 0.8 T to 1.4 T. The galvanomagnetic detector 25 for example has 4 measurement fields which are arranged in the shape of a cross. The measurement fields which are opposite one another on a crossbeam path are coupled to one another. This arrangement yields a simple direct evaluation possibility of the angle of the magnetic field by way of an arctangent relation.

For example, the distance “a” from adjacent permanent magnets is 50 mm. The width of the permanent magnet or its diameter measured in the measurement direction is 10 mm. The distance of the measurement fields of the galvanomagnetic detector from the permanent magnets is for example 6 mm. The permanent magnets which can be made as simple steel magnets have a self-remanence of approximately (e.g., plus or minus 10%) 1 T. With an arrangement of three such permanent magnets, distances of 100 mm and more can be monitored and the position of the monitored component can be directly ascertained from the linear relationship of the displacement path and of the measured signal. The tolerance with respect to the positioning accuracy of the galvanomagnetic detector with reference to the permanent magnet can be very high and up to several centimeters. Accordingly the system can be durable and insensitive to vibrations.

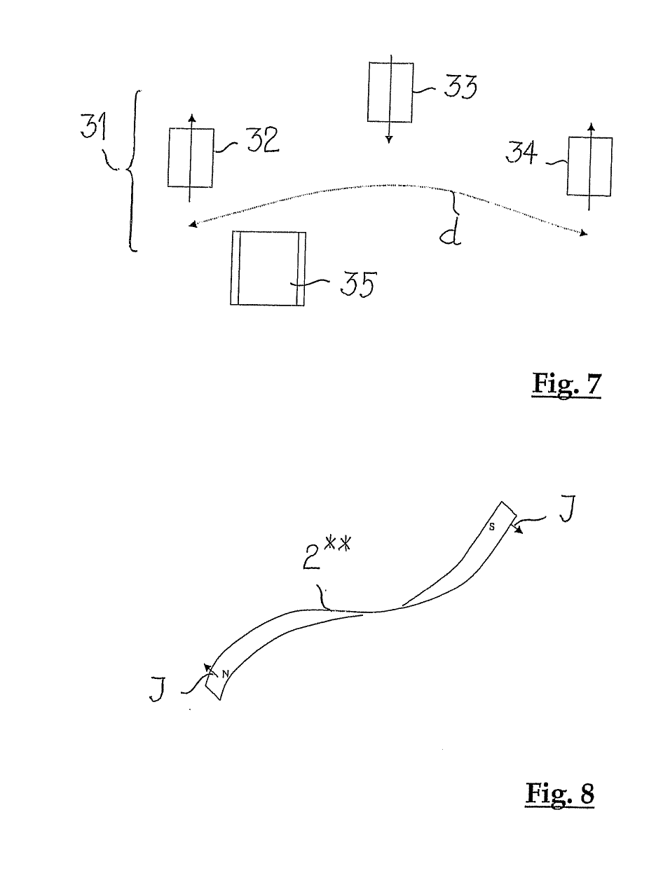

The magnetic position sensor as disclosed herein is not limited to detection of linear displacements of components. FIG. 7 shows, for example, a magnetic position sensor 31 whose permanent magnets 32, 33, 34 are located along a plane curved path. The displacement path of the monitored component which corresponds to the displacement path of the galvanomagnetic detector 35 which is provided with reference number 35 is indicated as a curved path “d” in FIG. 7.

In an exemplary embodiment which is not detailed, four or more permanent magnets can be located with respectively opposite polarities of adjacent permanent magnets along a circular path. The galvanomagnetic detector can then be moved along this circular path and enables angular measurement of a rotating component.

The arrangement of the permanent magnets is not, for example, limited to one plane. In another exemplary embodiment the individual permanent magnets can also be located along a path which is curved arbitrarily in space. This enables simple monitoring of the corresponding displacement paths which run optionally curved in space.

FIG. 8 schematically shows an exemplary permanent magnet 2** which, in an analogy to the permanent magnet shown in FIG. 1, is twisted along its extension by 180°. The polarity which changes over its extension as a result of twisting is indicated by arrows J. The permanent magnet 2** can be made as a flexible tape which, in addition to its twisting, describes an arbitrary curve in space. Thus, simple monitoring and position-finding of a component which can be moved along a path which is accordingly arbitrarily curved in space are possible. It goes without saying that the magnetic tape by analogy to the permanent magnet shown in FIG. 2 can also be twisted twice. Embodiments are also possible in which the magnetic tape is twisted more often over its lengthwise extension along the displacement path.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. Magnetic position sensor for detecting the location of a component which can be moved along an actuating path,
comprising means, located along an actuating path, for generating a magnetic field whose polarity changes along the actuating path; and
at least one galvanomagnetic detector which is located in a region of action of the magnetic field with at least two measurement fields and which can be adjusted relative to the magnetic field along the actuating path, wherein the galvanomagnetic detector is made for vectorial evaluation of the magnetic field.

2. Magnetic position sensor as claimed in claim 1, wherein the galvanomagnetic detector comprises:
four measurement fields which are arranged in a shape of a cross, with measurement fields which are opposite one another on a crossbeam being coupled to one another.

3. Magnetic position sensor as claimed in claim 2, wherein the measurement fields are magnetoresistors.

4. Magnetic position sensor as claimed in claim 1, wherein the galvanomagnetic detector is a Hall sensor element with two differential Hall sensors which are arranged crossed.

5. Magnetic position sensor as claimed in claim 1, wherein the means for generating the magnetic field comprises:
at least one permanent magnet which is polarized perpendicularly to a measurement direction of the galvanomagnetic detector and whose magnetic field polarity changes over a lengthwise extension of the permanent magnet.

6. Magnetic position sensor as claimed in claim 5, wherein the at least one permanent magnet is twisted by at least 180° over the lengthwise extension.

7. Magnetic position sensor as claimed in claim 5, wherein the permanent magnet follows an arbitrary three-dimensional curve.

8. Magnetic position sensor as claimed in claim 1, wherein the means for generating the magnetic field comprises:
two or more permanent magnets which are polarized perpendicularly to a measurement direction of the galvanomagnetic detector and are arranged to one another such that adjacent permanent magnets have opposite polarities.

9. Magnetic position sensor as claimed in claim 8, wherein the permanent magnets are located along a linearly running path.

10. Magnetic position sensor as claimed in claim 8, wherein the permanent magnets are located along a curved plane path.

11. Magnetic position sensor as claimed in claim 8, wherein the permanent magnets are located along an arbitrarily curved path in space.

12. Magnetic position sensor as claimed in claim 8, wherein the permanent magnets are configured such that permanent magnets which are adjacent to one another are located at a distance from 10 mm to 100 mm from one another, have a self-remanence of 100 mT to 1.5 T, a diameter from 2 mm to 30 mm, and an overall length which is approximately 0.1 times to 1.5 times the diameter, and wherein a distance of the two measurement fields of the galvanomagnetic detector to the permanent magnets is 10 mm to 30 mm.

13. Magnetic position sensor as claimed in claim 6, wherein the permanent magnet follows an arbitrary three-dimensional curve.

14. Magnetic position sensor as claimed in claim 3, wherein the means for generating the magnetic field comprises
two or more permanent magnets which are polarized perpendicularly to a measurement direction of the galvanomagnetic detector and are arranged to one another such that adjacent permanent magnets have opposite polarities.

15. Magnetic position sensor as claimed in claim 14, wherein the permanent magnets are configured such that permanent magnets which are adjacent to one another are located at a distance from 10 mm to 100 mm from one another, have a self-remanence of 100 mT to 1.5 T, a diameter from 2 mm to 30 mm, and an overall length which is approximately 0.1 times to 1.5 times the diameter, and wherein a distance of the two measurement fields of the galvanomagnetic detector to the permanent magnets is 10 mm to 30 mm.

16. Magnetic position sensor as claimed in claim 1, in combination with a component moved along the actuating path, a position of the component being detected by the magnetic position sensor.
